(19) United States
(12) Patent Application Publication
(10) Pub. No.: US 2014/0135090 A1
(43) Pub. Date: May 15, 2014

(54) GAME AND GAMING MACHINE HAVING PLAYER-SELECTABLE BONUS TARGET

(71) Applicant: Elia Rocco Tarantino, Las Vegas, NV (US)

(72) Inventor: Elia Rocco Tarantino, Las Vegas, NV (US)

(21) Appl. No.: 14/072,194

(22) Filed: Nov. 5, 2013

Related U.S. Application Data
(60) Provisional application No. 61/724,745, filed on Nov. 9, 2012.

(51) Int. Cl. G07F 17/32

(52) U.S. Cl. CPC G07F 17/3293
USPC 463/13; 463/25

(57) ABSTRACT

A game and gaming machine includes a randomly initiated bonus event. Upon triggering of the bonus event the player selects at least one designated bonus outcome. If the player receives the bonus winning outcome as a result of the play of a game while the bonus event is active, the player is awarded a bonus award. The bonus event may be active during one or more games after it is triggered. In one embodiment, the bonus award comprises a multiplier of a base pay table award for the bonus winning event.

### RELATED APPLICATION DATA

This application claims priority to U.S. Provisional Patent Application Ser. No. 61/724,745, filed Nov. 9, 2012.

### FIELD OF THE INVENTION

The present invention relates to gaming machines and methods of presenting and playing games.

### BACKGROUND OF THE INVENTION

A variety of casino-style games are known. These games include the popular games of video poker and spinning mechanical reel or video slots.

Gaming machine manufacturers have modified these types of games in order to increase their excitement level. As one example, gaming machine manufacturers have licensed various television or movie themes and have developed gaming machines around those themes. For example, slot machines have been developed which, instead of using old style symbols such as BAR, cherries and the like, use symbols which are associated with a television or movie theme.

Likewise, gaming machine manufacturers have added features to video poker and slot games. For example, the game of MEGA BUCKS® which is offered by IGT is a slot game in which a player wins a large progressive jackpot if the player achieves a particular game-winning combination of symbols when the player has placed a maximum wager. In the case of TRIPLE PLAY POKER®, a player is offered the opportunity to play multiple video poker hands at the same time as part of a single game.

Other games include a base game portion and a bonus game portion or offer the player an opportunity for an enhanced payout. For example, U.S. Pat. No. 5,542,669 to Charron discloses a video poker game where winning hands have associated awards. At the beginning of each game, the gaming machine randomly selects one of the winning hands and increases the award for that hand, which higher award is paid to the player if the player is able to achieve that particular winning hand while playing that instance of the game. As another example, U.S. Pat. No. 6,231,445 to Acres discloses a gaming system where slot games have designated winning outcomes and associated awards. At one or more times a particular winning outcome is designated as a bonus outcome having an associated bonus award which starts at an initial value and decreases as time elapses during a bonus period. The players of the gaming machines on the system attempt to achieve that bonus outcome during the bonus time period. If a player achieves the bonus outcome before the time period expires, the player is paid an award.

Despite the existing game variations, a need still exists for additional new and exciting game variations.

### SUMMARY OF THE INVENTION

Embodiments of the invention comprise gaming machines, methods of presenting and playing games, and bonus events for games and gaming machines.

In one embodiment of the invention, one or more first wagering games are presented to a player. Each wagering game has an outcome, such as a losing outcome or such as a winning outcome which is designated by a pay table of base winning outcomes having associated base awards.

At one or more times a bonus event may be initiated. Preferably, the bonus event is initiated randomly. If the bonus event is initiated, the player is permitted to designate one or more bonus winning outcomes. Preferably, the bonus winning outcome is selected from the base winning outcomes.

One or more second wagering games are then presented to the player. If the outcome of the second wagering game is losing, then the game ends and the player loses their wager. If the outcome of the second wagering game is a base winning outcome, then the player is awarded the associated base award based upon the pay table. If the outcome of the second wagering game is the bonus winning outcome which was selected by the player, then the player is awarded the bonus award there for.

In one embodiment, the bonus event remains active for a number of second games. The number of games which the bonus event remains active for may be randomly selected or determined and may thus vary for each bonus event.

In a preferred embodiment, the bonus award comprises an award which is greater in value than the base award for that outcome. In a most preferred embodiment, the bonus award comprises a multiple of the base award, such as the base award multiplied by a multiplier value of 2, 3, 4 or the like.

The game of the invention may have various implementations. In one embodiment, if a player receives the bonus winning outcome then the bonus event ends (even if there were still additional games during which the bonus event would have remained active). In one embodiment, a presentation event may be used to present the player with information regarding the duration of the bonus event (such as the number of games during which the bonus event will be active), the value of the bonus award and the like. For example, the player might spin a wheel wherein the outcome of the wheel spin determines the bonus award multiplier and the number of games that the bonus event remains active.

In one embodiment, a player may be permitted to select more than one bonus winning outcome or more than one bonus event may be active relative to a particular second game.

Embodiments of the invention also include a gaming machine which is configured to present the game and/or gaming systems for presenting the game(s).

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a gaming machine in accordance with the present invention;

FIG. 2 is a flow diagram illustrating one embodiment of a method of a game of the invention;

FIG. 3 schematically illustrates game play in accordance with an embodiment of the invention;

FIG. 4 illustrates one embodiment of the presentation of bonus award information in accordance with an embodiment of the invention; and

FIG. 5 illustrates another example of a game of the present invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games and bonus events for games and gaming machines. In a preferred embodiment, the methods of game play and presentation are implemented via a gaming machine or device 22. Such a gaming machine 22 may have various configurations.

The gaming machine 22 may be located at a casino (and as such is referred to as a “casino gaming machine”). As described below, the gaming machine 22 may be part of a gaming system, such as a casino gaming system which links multiple of the gaming machines, one or more table games and other devices such as kiosks, accounting systems or servers, progressive systems or servers, player tracking systems or servers or the like.

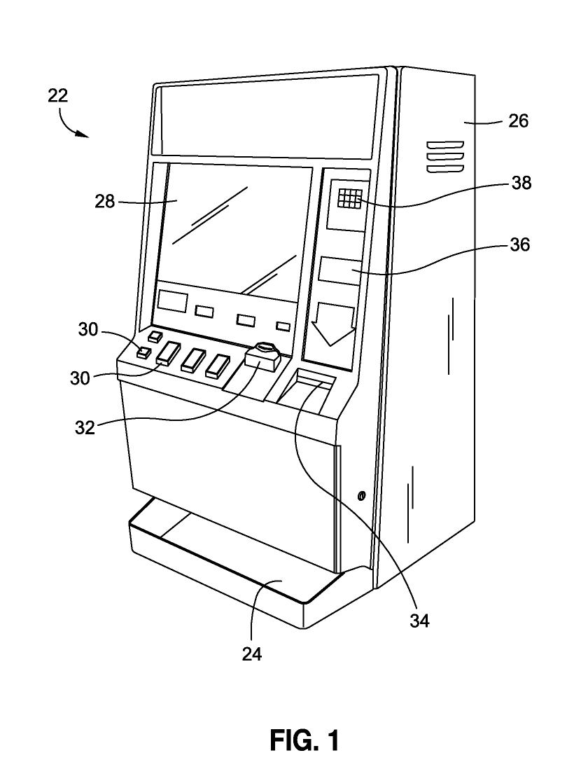

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting cards and for presenting the game in a random fashion.

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause slot reels (relative to a slot game) or playing cards (relative to a video poker game) to be displayed on the at least one display 28. The controller may accept input from a player of reels to spin, cards to be held or discarded or the like (depending upon the game being played/presented) via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray 24. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 36 and associated keypad 38. Such player tracking devices are well known and may permit the game operator to track play of players of the gaming machine. The tracked play may be utilized to offer player bonuses or awards.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, it is possible for the game of the invention to be presented on a computing device, including at a home or office computer. In one embodiment, a player might log in to a casino server and the controller of the casino server may cause game information to be delivered to the player's computer and then be displayed on a display of the player's computer. In this regard, it will be noted that the term “controller” may comprise more than one device. For example, in a server-based environment, a controller at a server may generate game information and transmit that information to a local controller at a gaming machine. The local controller at the gaming machine may then cause game information to be displayed on the display of the gaming machine. The games of the invention could also be presented by or at hand-held devices, such as PDAs, cellular phones, tablet computing devices or the like.

In another embodiment, the gaming machine 22 may include one or more physical reels capable of displaying symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference. For example, the base symbols might be associated with spinning reels. Sets of base symbols might be generated by spinning those reels.

A casino may have numerous such gaming machines 22, such as located on a casino floor or in other locations. Of course, such gaming machines 22 might be used in other environments, such as an airport, a bar or tavern or other locations.

As indicated, aspects of the invention comprise a bonus event and methods of presenting and playing games with an associated bonus event. In one embodiment of the invention, at one or more times a bonus event is initiated relative to the play of one or more games. In a preferred embodiment, the bonus event is randomly triggered.

If the bonus event is triggered, a player is preferably given the opportunity to select one or more bonus winning outcomes. In one embodiment, the one or more bonus winning outcomes may comprise some, but not all, of the base winning outcomes defined by a pay table for a game. In other embodiments, the player might be permitted to select other game outcomes. Preferably, an award is associated with the player-selected bonus winning outcome. If the bonus winning outcome is a base winning outcome (i.e. one that is already defined as a winning outcome for the game having an associated pay table award), then the award may comprise an award which has a higher value that the base award there for. Otherwise, the award for the bonus outcome may comprise an award which is yielded for the outcome when such an outcome would otherwise not be a winning outcome.

In accordance with the invention, a player may play one or more first games. These games may have outcomes which are losing or which are winning, such as comprising a designated base winning outcome having a base award. After the bonus event is initiated, the player is preferably given one or more second games to attempt to obtain the designated bonus winning outcome. The outcome of those second games may be losing, may be a winning outcome which comprises a base winning outcome but not the bonus winning outcome, or may be the bonus winning outcome.

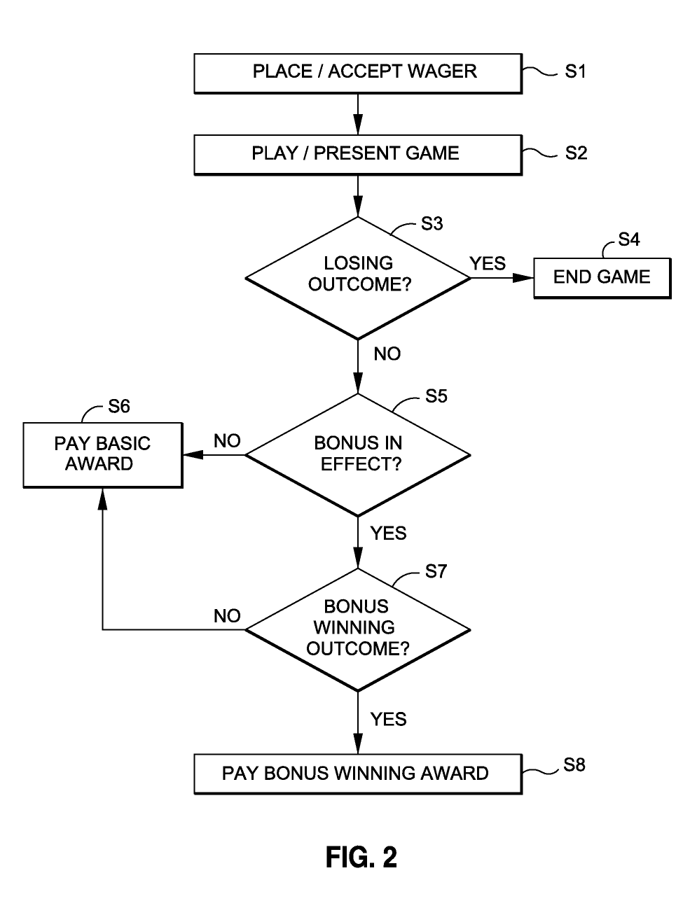

FIG. 2 schematically illustrates one embodiment of game play in accordance with the present invention. As illustrated, in a step S1 a player preferably places a wager. As indicated above, such could comprise the wagering of one or more credits at a gaming machine.

In a step S2, a base game is presented and played. The base game might comprise, for example, a game of video poker, video slots, blackjack or the like. Of course, the principles of the invention may apply to a wide range of other types of games. Preferably, the base game has a pay table which defines one or more, but not all, of the outcomes of the game as being winning (the remaining games being losing). Each winning outcome preferably has a base award (the losing outcomes preferably have no award).

In a step S3, the outcome of the game is determined. If the outcome of the game is a losing outcome, then in a step S4, the game ends and the player preferably loses their wager.

In step S3 if the outcome is winning, then in a step S5 it is determined if the bonus event is in effect. If not, then in step S6 the player is paid any associated award for winning outcome. Preferably, the award comprises a base award which is determined by a base pay table for the game.

On the other hand, if in step S5 it is determined that the bonus event is in effect, then it is determined if the winning outcome is a bonus winning outcome. If not, then the player is paid the normal or base award, as in step S6. If so, then in step S8 the player is paid the bonus winning award for the bonus winning outcome.

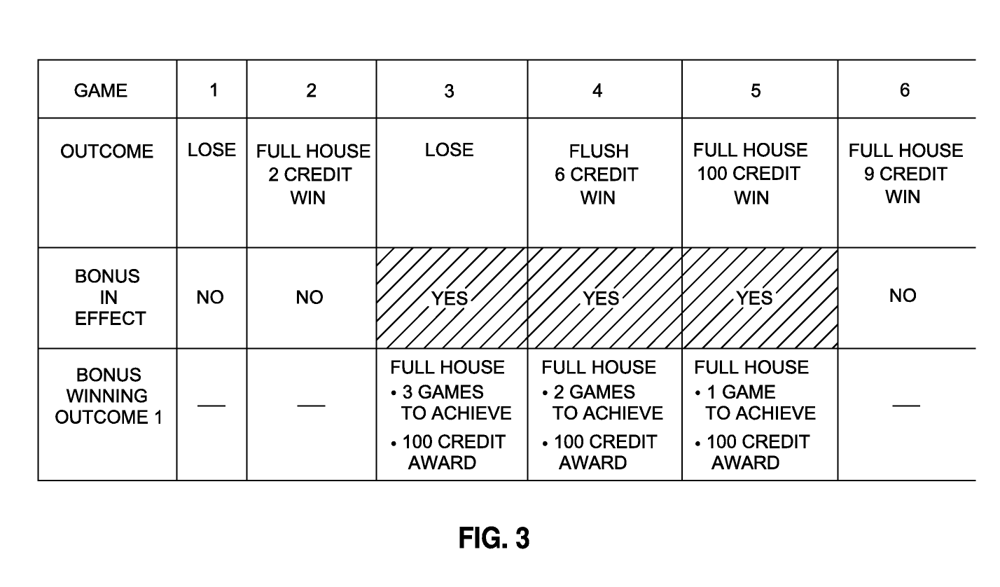

One example of the invention will be described with reference to FIG. 3. In this example, each base game is a game of video poker. Set forth below is an exemplary pay table of designated winning outcomes and associated base awards:

| Hand | Payout |
|---|---|
| Royal Flush | 800 |
| Straight Flush | 50 |
| Four of a Kind | 25 |
| Full House | 9 |
| Flush | 6 |
| Straight | 4 |
| Three of a Kind | 3 |
| Two Pair | 2 |
| Pair (Jacks or Better) | 1 |

As illustrated in FIG. 3, the player has placed a wager and played a first game of video poker. The result of that game was a losing outcome (i.e. not one of the designated outcomes of the pay table set forth above). Thus, the player lost their wager and did not receive an award.

In a second game, the player received a Two Pair outcome. This outcome is one of the winning outcomes. Because no bonus event is in effect, the player is paid the base award for that outcome, or 2 credits.

After the player played the second game, a bonus event was initiated. As a result, the player was given the opportunity to select a particular outcome to comprise a bonus winning outcome. The player selected the outcome of a Full House as the bonus winning outcome and was given 3 games to achieve that outcome. In this example, the bonus award for receiving the bonus winning outcome has been designated as 100 credits. Notably, this 100 credit award is substantially higher than the normal 9 credit base award for that same outcome (a Full House).

In the next game, the third game, the player received another losing outcome. As a result, the player lost their wager and was not awarded any winnings. The player then had 2 remaining games in which to achieve the bonus winning outcome.

In the fourth game, the player received a winning Flush outcome. While this outcome is a winning outcome, it was not the bonus winning outcome. As a result, the player was awarded 6 credits. The player then had a single remaining game in which to achieve the bonus winning outcome.

In the fifth game, the player received a winning Full House outcome. Because this outcome was received while the bonus event was still in effect and because the outcome comprised the bonus winning outcome, the player is paid the bonus winning award, or 100 credits.

In this example, the bonus event has then ended and in the next game, the sixth game, the player has again received a Full House winning outcome. However, because the bonus event has ended, the player is only awarded the base award of 9 credits for that winning outcome.

A variety of additional aspects of the invention will now be described, including various features and implementations of the invention.

In one embodiment, a bonus event remains in effect for a designated number of games (such as hands of poker, slot spins or the like). For example, a player might select the bonus winning outcome of a Flush relative to a video poker game and the bonus event might remain in effect for 20 games or hands. In other embodiments, the bonus event might remain in effect for a certain period of time.

As indicated above, in a preferred embodiment, a bonus event is randomly initiated. For example, a random number generator may be used to generate numbers between 1 and 1000. Each time a game is played, the random number generator may be used to generate a number. If the generated number matches a designated number, such as 500, then the bonus event may be initiated. In this example, the bonus event would be initiated, on average, 1 of every 1000 games played. However, the bonus event could be initiated based upon a higher or lower frequency and by other mechanisms.

In one embodiment, a player is permitted to designate a single bonus winning outcome relative to a bonus event. As indicated, the bonus winning outcome might be selected from an existing set of winning outcomes. For example, upon initiation of a bonus event, the player might be presented with the pay table of winning outcomes for the game and may be presented with the opportunity to provide input regarding the selection of one or more of those outcomes.

However, the player might be permitted to select other outcomes. For example, while the poker hand 2, 4, 6, 8, 10 is not a winning poker hand, the player might be permitted to designate such a hand as a bonus winning outcome.

In another embodiment of the invention, a player may be permitted to designate more than one bonus winning outcome. In one preferred embodiment, a random number generator or the like may be used to determine how many outcomes (preferably in a range, such as 1 to 5) that a player may designate as bonus winning outcomes.

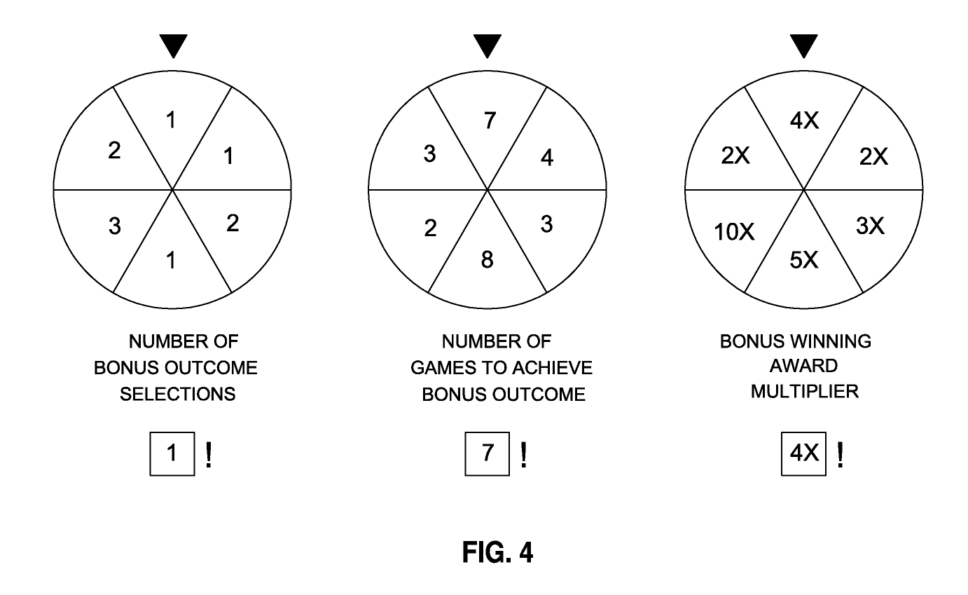

In one embodiment, one or more presentation events might be used to present information to the player regarding the bonus event. The presentation event(s) could comprise, for example, entertaining and stimulating events presented by the one or more displays of a gaming machine. As one example, a player might be presented with a wheel which has segments. One or more or all of the wheel segments may bear numbers which indicate the number of bonus winning outcomes which the player may designate. For example, as illustrated in FIG. 4, a wheel might have six segments which bear the numbers 1, 2, 3, 1, 1 and 2. In this configuration, the player has a 1 in 2 chance of being able to designate a single bonus winning outcome, a 1 in 3 chance of being able to designate two bonus winning outcomes, and a 1 in 6 chance of being able to designate three bonus winning outcomes. The wheel may be spun relative to a designator/pointer or the designator may move relative to the wheel to result in the selection of one or more of the segments (it will be appreciated that the wheel may be a graphical representation of a wheel which is displayed on an electronic video display, or the wheel might comprise a physical wheel).

Of course, presentation events or features other than a spinning wheel might be used to present the player with the number of bonus winning outcomes. For example, a plurality of boxes might be displayed to the player where each box hides a number. The player may be permitted to select one or more boxes to reveal a number which represents the number of bonus winning outcomes which the player may select.

As indicated, the bonus event preferably has a duration. In a preferred embodiment, after a bonus event is initiated, a player preferably has a number of games in which to achieve that outcome in order to receive the bonus award. In one embodiment, the number of games may be randomly chosen, such as by using a random number generator (again, the range of the number of games may be limited, such as between 1 and 50, as one example).

Information regarding the duration of the bonus event may be presented via a presentation event. In one embodiment, as illustrated in FIG. 4, a player might be presented with a wheel which has segments, one or more or all of which bear numbers which indicate the number of games which the player has to achieve the bonus winning outcome. As also described above, other features may be used to present the number of games, such as boxes, etc.

As indicated above, the bonus winning outcome preferably has an associated bonus winning award. In one embodiment, the bonus winning award may comprise a numerical credit value which is higher than a credit value of a base award for that outcome. However, in a preferred embodiment, the bonus winning award comprises a multiplier value, which multiplier value is applied to the base award for that outcome.

For example, a base award for a winning Full House poker hand in a game of video poker may comprise 9 credits. The bonus winning award may comprise a 3× multiplier, or an award of 27 credits.

In one embodiment, the bonus winning award may again be presented to the player via various presentation events. For example, as illustrated in FIG. 4, a player may be presented with a wheel which has a plurality of segments, one or more of the segments bearing a multiplier value. The player may spin the wheel to generate a multiplier for a particular bonus winning outcome.

It will be appreciated that wheels or other presentation events may be used to present information which is pre-selected or may be used to present a random outcome. For example, relative to the number of bonus winning outcomes which the player may select, the gaming machine may determine that number before the presentation event. For example, the gaming machine might select the number 2. Then the presentation event, such as the rotation of a wheel, might simply comprise the presentation of that pre-selected number (i.e. when the wheel is rotated it is stopped on a segment which displays “2”). In another embodiment, it is possible for the wheel to be randomly stopped, such as that the random stopping position is associated with a random outcome.

In a preferred embodiment of the invention, the criteria for the bonus event are “built”, such as by having the player select a bonus winning outcome, generating a number which represents the number of games comprising the duration of the bonus events, generating a number which represents the bonus winning award, etc. In other embodiments, however, a player might be presented with particular bonus winning outcome options and the player might select from those options. As one example, a set of options might comprise:

Option 1: Full House; 2 games to achieve outcome; 3× multiplier

Option 2: Flush; 4 games to achieve outcome; 2× multiplier

Option 3: Royal Flush; 1 game to achieve outcome; 10× multiplier

In this configuration, a player may be required to weigh criteria associated with the various options as part of making their selection. For example, while in this example the Royal Flush option offers the highest multiplier value (and thus a tremendous bonus winning award), the player is only given 1 game to achieve that outcome. This option is contrasted with Option 2 where the player has 4 games to achieve the much higher probability Flush outcome, but only receives a 2× multiplier if that outcome is achieved.

Of course, various options may be presented to the player for their selection. The various criteria for those options may vary and include features other than just described.

In one embodiment of the invention, as indicated above, a player might have the opportunity to designate more than one bonus winning outcome. In one configuration, the player might be required to select a different bonus winning outcome for each selection. In another configuration, the player might be permitted to select the same bonus winning outcome. For example, if the player is given the opportunity to select 2 bonus winning outcomes, the player might select as the first outcome a Full House and as the second outcome a Straight. These bonus winning outcomes might have the same associated criteria (such as the same number of games for achieving the outcome and the same multiplier values) or different ones. In this example, the player might instead designate a Full House for both bonus winning outcomes. In such event, the player might receive two bonus winning awards for receiving the single bonus winning outcome.

In one embodiment, there may be different bonus events and associated bonus winning outcomes which are active at different times. For example, a first bonus event might be triggered and last for 4 games. After the second of those 4 games, a second bonus event might be triggered and last 6 games. In this scenario, for games 3 and 4, both bonus events are active.

In a preferred embodiment, once a bonus winning outcome is achieved, the bonus event ends, even if there are remaining games for achieving the bonus winning outcome. In another embodiment, the bonus event could remain in effect until all games have expired (such that the player could achieve a bonus winning outcome more than one time).

In one embodiment if a second bonus event is triggered while a first bonus event is active, the player may be permitted to “reserve” the second bonus event until the conclusion of the first bonus event.

In another embodiment, various features may change the criteria of the bonus event. For example, if a player achieves certain criteria while a bonus event is active, that bonus event may be extended. For example, each time a player receives an Ace in a game of video poker (or other designated card or cards, on the deal and/or on the draw) while a bonus event is active, the number of games during which the bonus event is active may be increased or incremented by one (1), thus extending the bonus event. This provides the player with additional hands to attempt to obtain the target bonus winning outcome.

As indicated, the principles of the invention can apply to other games, such as blackjack. For example, a player might play games of video blackjack. Certain outcomes, such as blackjack hands may be awarded winnings. Upon a bonus event of the present invention, a player might select one or more blackjack game outcomes as a bonus winning outcome. For example, a player might select the blackjack hand A [symbol] J [symbol] . If the player achieves that hand during the bonus event (such as within the designated time or number of games/hands), then the player may be paid a bonus award. Such an award might comprise, as one example, a multiplier of the base winnings such as 2×, 4×, 6×, etc. times the base award for that outcome.

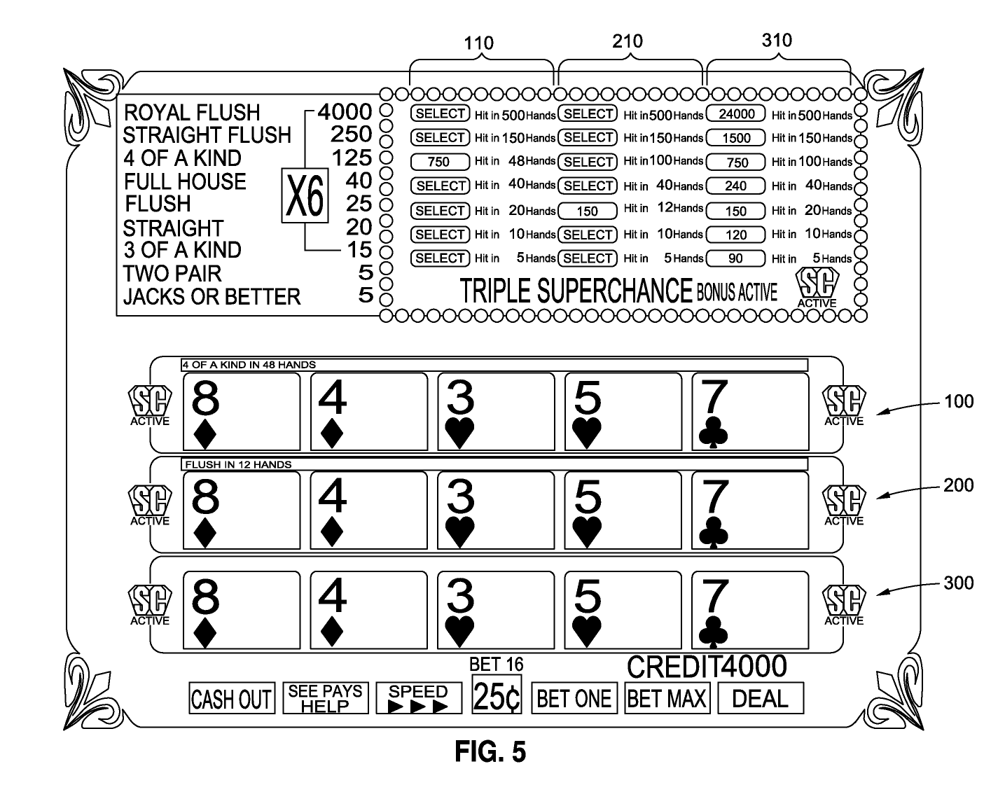

Another example of the invention is illustrated in and will be described with reference to FIG. 5. In various games, a player may play one or more games at the same time, such as one or more poker hands. For example, in the popular game of Triple Play®, a player may play three hands of video poker at the same time, wherein the outcome of the game involves evaluation the outcome of each of the hands. FIG. 5 illustrates a similar game in which a player is playing a first poker hand 100, a second poker hand 200 and a third poker hand 300. As one aspect of the invention, the bonus event of the present invention might be activated relative to any one of the hands or two or more or all of the hands. For example, a first occurrence of the bonus event might be activated relative to the first poker hand 100 without being activated relative to the second or third poker hands 200,300. Of course, when the bonus events are separately activated, they might overlap one another in duration. For example, a particular trigger (such as via a first RNG) might trigger the bonus event relative to the first poker hand 100 at a first time and a different trigger (such as via a different RNG) might trigger the bonus event relative to the third poker hand 300 at a different time.

In another embodiment, when the bonus event is activated, it is activated relative to all of the games or hands. In such a configuration, the bonus event may be activated and apply to the first poker hand 100, the second poker hand 200 and the third poker hand 300. As indicated above, in accordance with the invention, upon activation of the bonus event the player is permitted to designate a bonus winning outcome. In the embodiment where the game involves multiple hands or other separate features, the player might designate a single bonus winning outcome which applies to all of the hands or features. For example, the player might designate the bonus winning outcome as a Four of a Kind poker hand. If the player then receives a Four of a Kind relative to any of the multiple poker hands which the player is playing, then the player would achieve a bonus winning outcome. In another embodiment, the player is permitted to designate a different bonus winning outcome for each poker hand.

One example of the invention is illustrated in FIG. 5, wherein tables of bonus winning outcomes and their associated criteria may be displayed relative to each poker hand (such as a first table 110 corresponding to the first poker hand 100, a second table 210 corresponding to the second poker hand 200, a third table 310 corresponding to the third poker hand 300). The player may then make a selection or designation of a bonus winning outcome relative to each hand (which designation might be the same or different for each hand).

In the illustrated embodiment, each of the tables 110,210,310 identifies the same bonus winning outcomes and associated criteria. However, the bonus winning outcomes and associated criteria for the hands might be different.

In the illustrated configuration, the bonus event has been triggered or activated relative to the first poker hand 100. The player selected the bonus winning outcome “4 of a Kind” for the first poker hand 100. This bonus winning outcome offers a bonus award of 750 credits if it is achieved in the first poker hand 100 within 100 games/hands. As illustrated, the player has played a number of first poker hands 100, leaving the player with 48 hands left within which to receive a 4 of a Kind in order to receive the bonus winning outcome.

In this same example, the bonus event has been triggered or activated relative to the second poker hand 200. The player selected the bonus winning outcome of “Flush” for the second poker hand 200. This bonus winning outcome offers a bonus award of 150 credits if it is achieved in the second poker hand 200 within 20 hands. As illustrated, the bonus event was activated relative to the second poker hand 200 at a different time than the first poker hand 100, such that the player has only 12 hands left within which to receive a bonus winning Flush outcome in the second hand.

As also illustrated in FIG. 5, a bonus event has just been triggered or activated relative to the third poker hand 300. Thus, the player is permitted to make a selection of a bonus winning outcome relative to the third poker hand 300, such as from the third table 310. The player may then play one or more third poker hands 300 in an attempt to achieve the selected bonus winning outcome.

Of course, these principles may be applied to poker games having other than 3 hands, such as games having two poker hands or four or more poker hands. These principles might also be applied to other types of games. For example, a player might play a slot game where three rows or symbols are displayed. The principles of the invention might be applied to each of the rows of symbols, wherein a player attempts to achieve certain bonus winning combinations of symbols relative to each row.

The gaming machine and game of the invention have numerous advantages. A particular advantage of the invention is a game which offers the player the opportunity to select a desired bonus outcome. For example, in accordance with the present invention, a player may select a bonus winning outcome which has a high probability of being achieved, rather than configurations of the prior art where a gaming machine may offer a bonus but only for achieving a result which has such a low probability of occurring that it is essentially meaningless to the player.

Another advantage of the invention comprises a bonus event with an exciting presentation feature. In particular, in accordance with the invention a bonus event has a number of associated criteria, such as a player-selected bonus winning outcome, a number of games to achieve that outcome and a bonus award. In a preferred embodiment, a presentation event such as the spinning of one or more wheels, is used to present some or all of the bonus event information/criteria. The use of a presentation event adds to the excitement of the bonus event. This excitement is further enhanced when the player is involved in the presentation event, such as by providing input to spin one or more wheels or the like.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of presenting a game at an electronically controlled gaming machine comprising the machine implemented steps of:
presenting at least one first wagering game comprising the steps of:
accepting a wager;
presenting game information to said player via an electronic display of said gaming machine;
determining an outcome of said wagering game, wherein if said outcome is a base winning outcome, awarding a base award in accordance with a pay table;
and
randomly initiating a bonus event, said bonus event comprising receiving input of a player of at least one of said base winning outcomes to be designated as a bonus winning outcome;
indicating a bonus award for achieving said bonus winning outcome, said bonus award having a value greater than a base award for said outcome;
presenting at least one second wagering game, wherein if an outcome of said at least one second game is a winning outcome but not said bonus winning outcome, awarding said base award in accordance with said pay table to said player; and
if said outcome is said bonus winning outcome, then awarding said bonus award to said player.

2. The method in accordance with claim 1 wherein said at least one first wagering game comprises at least one game of video poker.

3. The method in accordance with claim 2 wherein said pay table defines a plurality of base winning poker hands each having an associated base award.

4. The method in accordance with claim 1 further comprising indicating a number of second games within which said bonus winning outcome must be achieved in order receive said bonus award.

5. The method in accordance with claim 4 wherein if said outcome is said bonus winning outcome, determining if said bonus winning outcome was received within said number of second games and: (1) if not, awarding said base award for said outcome and (2) if so, awarding said bonus award.

6. The method in accordance with claim 1 wherein said gaming machine comprises a computing device.

7. The method in accordance with claim 1 wherein said step of randomly initiating comprises initiating said bonus event independent of an outcome of a first wagering game.

8. The method in accordance with claim 1 wherein each base award comprises a number of credits and said bonus winning outcome comprises a number of credits which is greater than the number of credits comprising the base award for that outcome.

9. The method in accordance with claim 1 wherein said bonus winning outcome comprises a multiplier of at least 2 times said base award for that outcome.

10. The method in accordance with claim 1 further comprising utilizing a random number generator to initiate said bonus event.

11. The method in accordance with claim 1 wherein said first wagering game comprises at least two hands of poker and determining an outcome of each of said hands of poker, randomly initiating said bonus event relative to at least one of said hands and presenting at least one second wagering game comprising at least two hands of poker.

12. The method in accordance with claim 11 comprising initiating said bonus event relative to each of said at least two hands of poker and receiving input of a player of at least one of said base winning outcomes to be designated as a bonus winning outcome relative to each of said at least two hands of poker.

13. The method in accordance with claim 11 comprising initiating said bonus event relative to each of said at least two hands of poker, wherein a player may provide input of a different base winning outcome to be designated as a bonus winning outcome relative to each of said at least two hands of poker.
